(19) United States
(12) Patent Application Publication
(10) Pub. No.: US 2026/0121312 A1
(43) Pub. Date: Apr. 30, 2026

(54) TERMINAL FASTENING STRUCTURE

(71) Applicant: TOYOTA JIDOSHA KABUSHIKI KAISHA, Toyota-shi (JP)

(72) Inventors: Tetsuhiro TAKENAKA, Miyoshi-shi (JP); Masahiro Obata, Chiryu-shi (JP); Hironori Asaoka, Okazaki-shi (JP); Makoto Yoshikawa, Nisshin-shi (JP)

(73) Assignee: TOYOTA JIDOSHA KABUSHIKI KAISHA, Toyota-shi (JP)

(21) Appl. No.: 19/280,855

(22) Filed: Jul. 25, 2025

(30) Foreign Application Priority Data
Oct. 28, 2024 (JP) 2024-188888

(51) Int. Cl. H01R 9/24; H01R 9/18

(52) U.S. Cl. CPC H01R 9/2416; H01R 9/18; H01R 2201/10

(57) ABSTRACT

A terminal fastening structure includes a first terminal provided on a power line extending from a motor, a terminal block to which the first terminal is fastened using a bolt, and a second terminal provided on the terminal block and in contact with the first terminal when the first terminal is fastened to the terminal block, wherein the first terminal includes a plate-shaped terminal body in which a through hole or a notch through which the bolt is passed is formed, and a protrusion protruding from the terminal body, wherein the protrusion abuts on at least one of the second terminal and the terminal block in a circumferential direction around a rotational axis of the bolt.

### CROSS-REFERENCE TO RELATED APPLICATION

This application claims priority to Japanese Patent Application No. 2024-188888 filed on Oct. 28, 2024. The disclosure of the above-identified application, including the specification, drawings, and claims, is incorporated by reference herein in its entirety.

### BACKGROUND

### 1. Technical Field

The present specification relates to a terminal fastening structure for fastening a terminal to a terminal block.

### 2. Description of Related Art

Japanese Unexamined Patent Application Publication No. 2020-145888 (JP 2020-145888 A) discloses a bus bar fixing structure including a first bus bar extending from a motor, and a second bus bar to which the first bus bar is fastened using a bolt. The second bus bar has a columnar shape, and the first bus bar is in contact with a distal end of the second bus bar that is columnarly shaped.

### SUMMARY

When the first bus bar is fastened to the second bus bar using the bolt, torque is transmitted from the bolt to the first bus bar. The torque can cause the first bus bar to rotate with respect to the second bus bar. At the distal end of the columnar shape thereof that is described in JP 2020-145888 A, even when the first bus bar rotates with respect to the second bus bar, an area of contact in which the first bus bar and the second bus bar come into contact with each other hardly changes. However, the shape of the bus bar is not necessarily a columnar shape. This is because the shape of the bus bar is constrained by space in which the bus bar can be routed. In other words, due to spatial constraints, there are cases in which routing and shape that do not change the area of contact of the bus bar cannot be selected. A phenomenon in which the area of contact changes due to the rotation of the bus bar causes variance in the area of contact during mass production. The present specification provides technology for suppressing variance in area of contact between a first terminal and a second terminal.

A terminal fastening structure disclosed in the present specification includes a first terminal that is provided on a power line extending from a motor, a terminal block to which the first terminal is fastened using a bolt, and a second terminal that is provided on the terminal block, and that comes into contact with the first terminal when the first terminal is fastened to the terminal block, wherein the first terminal includes a terminal body that is plate-shaped, in which a through hole or a notch through which the bolt is passed is opened, and a protrusion that protrudes from the terminal body, and the protrusion abuts at least one of the second terminal and the terminal block in a circumferential direction about a rotational axis of the bolt.

According to the above configuration, even when the first terminal rotates about the rotational axis of the bolt, the protrusion of the first terminal abuts at least one of the second terminal and the terminal block, in the circumferential direction about the rotational axis. That is to say, rotation of the first terminal is stopped by the protrusion. Stopping the rotation of the first terminal enables variance in the area of contact between the first terminal and the second terminal to be suppressed.

Details of the technology that is disclosed in the present specification, and further improvements, will be described in the “DETAILED DESCRIPTION OF EMBODIMENTS” below.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a cross-sectional view of a motor unit including a terminal fastening structure;

FIG. 2 is a cross-sectional view of a terminal fastening structure in II-II;

FIG. 3 is a plan view, a side view, and a cross-sectional view of the first terminal; and

FIG. 4 is a cross-sectional view of a terminal fastening structure according to a second embodiment.

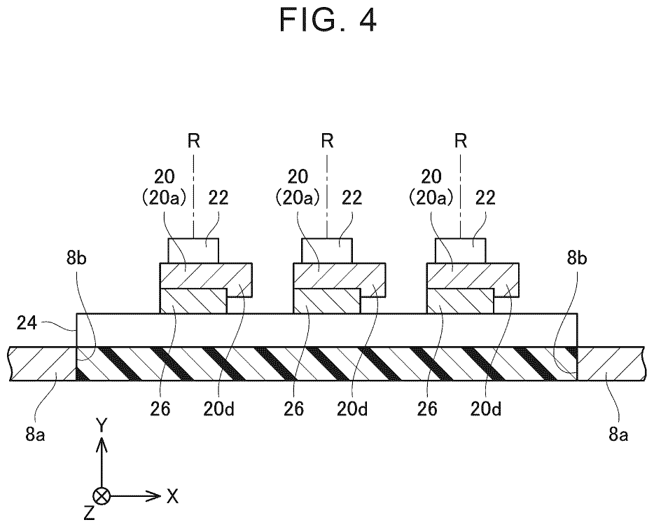

### DETAILED DESCRIPTION OF EMBODIMENTS

### First Embodiment

### Configuration of the Motor Unit 2

The motor unit 2 includes a terminal fastening structure 4, a motor 6, and a housing 8 according to the present embodiment. The motor unit 2 is mounted on vehicles such as battery electric vehicle, hybrid electric vehicle, for example. The motor 6 is used for, for example, generation of driving torque for traveling, power generation, and the like. The motor 6 is a three-phase AC motor. In the drawings, XYZ coordinates are defined. The Y-axis is parallel to the rotational axis of the motor 6.

The terminal fastening structure 4 is a structure for electrically connecting three power lines 10 extending from the motor 6 and three power lines 12 extending from a power conversion device (not shown). Each power line 10 and each power line 12 correspond to each phase of a three-phase alternating current. Here, the power conversion device is, for example, an inverter.

The housing 8 accommodates the motor 6. The terminal fastening structure 4 is provided on the side wall 8a of the housing 8. Here, the side wall 8a is a wall perpendicular to the rotational axis of the motor 6. In the modified example, the terminal fastening structure 4 may be provided on a wall of the housing 8 that is parallel to the rotational axis of the motor 6.

### Configuration of the Terminal Fastening Structure 4

The terminal fastening structure 4 includes three first terminals 20, a terminal block 24, and three second terminals 26. One first terminal 20 is connected to one second terminal 26. One first terminal 20 is provided on a corresponding one power line 10 of the three power lines 10 extending from the motor. One second terminal 26 is provided on a corresponding one power line 12 of the three power lines extending from the power converter 12. Here, the power line 10 is, for example, a braided wire, and the power line 12 is, for example, a cable.

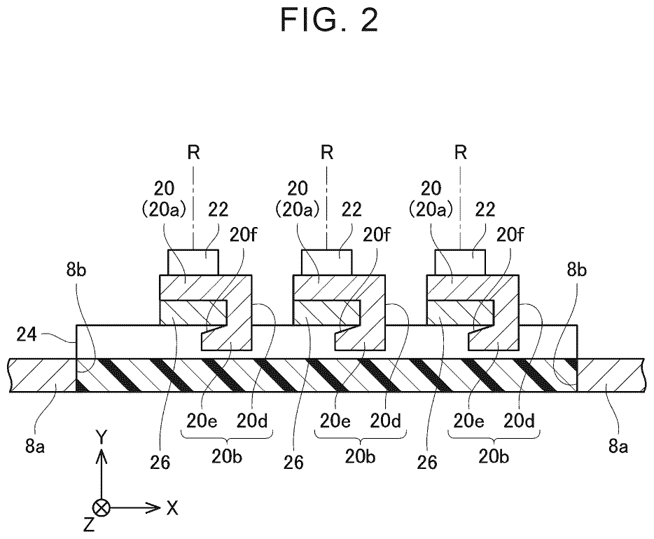

As shown in FIG. 2, the second terminal 26 is fixed to the terminal block 24. In the terminal block 24, the first terminal 20 is fastened using a bolt 22. When the first terminal 20 is fastened to the terminal block 24, the surface of the second terminal 26 (that is, the surface located in the Y-axis positive direction) is in contact with the back surface of the first terminal 20 (that is, the surface located in the Y-axis negative direction).

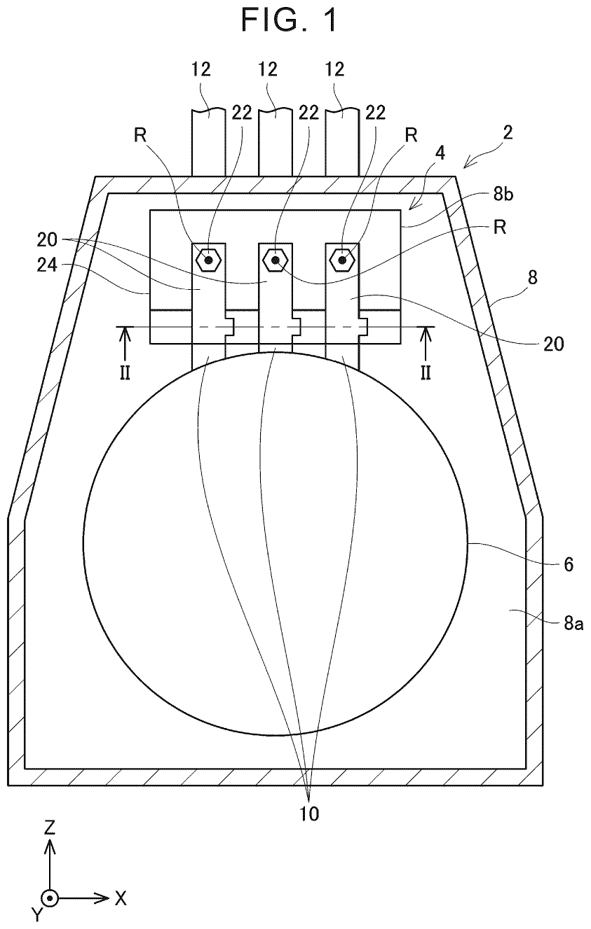

As shown in FIGS. 1 and 2, the terminal block 24 is attached to an opening 8b formed in the side wall 8a. A space between the terminal block 24 and the opening 8b is sealed by a sealing member (not shown).

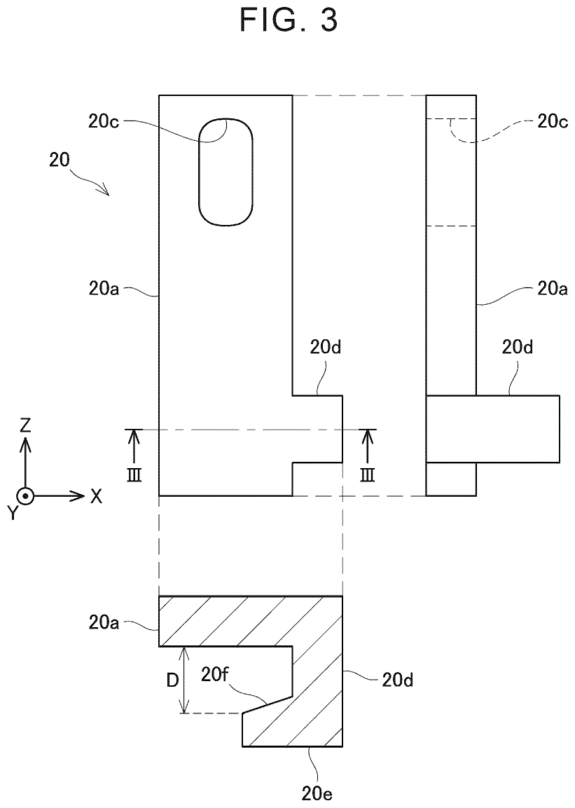

FIG. 3 shows the first terminal 20 separated from the terminal fastening structure 4. The upper left view is a front view, and the upper right view is a side view. Further, the lower left view is a cross-sectional view taken along III-III. XYZ co-ordinates in FIG. 3 correspond to a front view.

The first terminal 20 includes a plate-shaped terminal body 20a and a protrusion 20b. A through hole 20c through which the bolt 22 is passed is formed in the terminal body 20a. In the modification, a notch through which the bolt 22 is passed may be formed in the terminal body 20a. The protrusion 20b protrudes from the terminal body 20a and is formed along an outer edge of the terminal body 20a.

The protrusion 2b includes a protrusion body 20d and a sub-protrusion 20e. The protrusion body 20d extends from the outer edge of the terminal body 20a in the Y-axis negative direction. The sub-protrusion 20e extends from the distal end of the protrusion body 20d in the X-axis negative direction. The protrusion body 20d and the sub-protrusion 20e are plate-shaped.

A tapered portion 20f is formed on an inner surface of the sub-protrusion 20e facing the back surface of the terminal body 20a (that is, the surface located in the Y-axis negative direction). In the tapered portion 20f, the distance D between the terminal body 20a and the sub-protrusion 20e widens toward the distal end of the sub-protrusion 20e.

As shown in FIG. 2, when the first terminal 20 is fastened to the terminal block 24, the protrusion body 20d abuts against the outer edge of the second terminal 26. The sub-protrusion 20e extends from the distal end of the protrusion body 20d along the back surface of the second terminal 26 (i.e., the surface located in the Y-axis negative direction). The second terminal 26 floats from the surface of the terminal block 24 due to a step or the like. That is, a gap exists between the rear surface of the second terminal 26 and the surface of the terminal block 24. When the sub-protrusion 20e enters the gap, the sub-protrusion 20e extends along the back surface of the second terminal 26.

When the first terminal 20 is fastened to the terminal block 24 by using the bolt 22, the first terminal 20 rotates about the rotational axis R of the bolt 22. Here, the outer edge of the second terminal 26 is located in the circumferential direction around the rotational axis R. Therefore, when the first terminal 20 rotates about the rotational axis R of the bolt 22, the protrusion body 20d abuts against the outer edge of the second terminal 26. That is, the first terminal 20 stops rotating due to the protrusion body 20d. By stopping the rotation of the first terminal 20, it is possible to suppress variations in the area of contact between the first terminal 20 and the second terminal 26 during mass production.

Here, as shown in FIG. 3, the protrusion 20b is provided at a position away from the through hole 20c, that is, the rotational axis R of the bolt 22. For example, the through hole 20c is disposed between the center in the longitudinal direction (i.e., the Z-axis direction) of the terminal body 20a and one end in the longitudinal direction of the terminal body 20a. On the other hand, the protrusion 20b is disposed between the center in the longitudinal direction of the terminal body 20a and the other end in the longitudinal direction of the terminal body 20a. By separating the protrusion 20b from the through hole 20c, the load applied to the connecting portion between the protrusion 20b and the terminal body 20a can be reduced by the torque for rotating the bolt 22.

Further, the first terminal 20 vibrates when the vehicle on which the motor unit 2 is mounted travels. In the present embodiment, the terminal body 20a and the sub-protrusion 20e sandwich the second terminal 26. This makes it difficult for the terminal body 20a to vibrate along the Y-axis.

In addition, the tapered portion 20f facilitates passing of the second terminal 26 into the gap between the terminal body 20a and the sub-protrusion 20e.

### Correspondence

The terminal fastening structure 4, the housing 8, and the opening 8b are exemplary “terminal fastening structure”, “housing”, and “opening”, respectively. The motor 6 and the power line 10 are examples of a “motor” and a “power line”, respectively. The first terminal 20, the terminal body 20a, and the protrusion 20b are exemplary “first terminal”, “terminal body”, and “protrusion”, respectively. The protrusion body 20d, the sub-protrusion 20e, and the through hole 20c are exemplary “protrusion body”, “sub-protrusion”, and “through hole”, respectively. The tapered portion 20f is an exemplary “tapered portion”. The bolt 22, the terminal block 24, and the second terminal 26 are examples of “bolt”, “terminal block”, and “second terminal”, respectively. The rotational axis R and the distance D are examples of the “rotational axis” and the “distance”, respectively.

### Second Embodiment

This embodiment has the same configuration as the first embodiment except that the protrusion 20b does not include the sub-protrusion 20e. Also in this embodiment, when the first terminal 20 is fastened to the terminal block 24 using the bolt 22, the protrusion body 20d abuts against the outer edge of the second terminal 26, and the first terminal 20 stops rotating. This embodiment does not include the sub-protrusion 20e, and can be structurally simpler than the first embodiment.

In the following, points to be noted regarding the technology shown in the examples will be described. In the second embodiment, the protrusion body 20d may extend from the rear surface of the terminal body 20a of the first terminal 20 toward the second terminal 26. The second terminal 26 may be provided with a recessed portion for accommodating the protrusion body 20d. In this modification, the protrusion body 20d abuts against the inner surface of the recess of the second terminal 26 in the circumferential direction around the rotational axis R of the bolt 22.

Further, in the second embodiment, the protrusion body 20d may abut a part of the terminal block 24 instead of the second terminal 26.

In addition, in the first embodiment, a tapered portion 20f may not be formed in the sub-protrusion 20e.

What is claimed is:

1. A terminal fastening structure, comprising:
a first terminal that is provided on a power line extending from a motor; a terminal block to which the first terminal is fastened using a bolt; and a second terminal that is provided on the terminal block, and that comes into contact with the first terminal when the first terminal is fastened to the terminal block, wherein the first terminal
includes a terminal body that is plate-shaped, in which a through hole or a notch through which the bolt is passed is opened, and a protrusion that protrudes from the terminal body, and the protrusion abuts at least one of the second terminal and the terminal block in a circumferential direction about a rotational axis of the bolt.

2. The terminal fastening structure according to claim 1, wherein the protrusion is fashioned along an outer edge of the terminal body, and the protrusion abuts an outer edge of the second terminal.

3. The terminal fastening structure according to claim 2, wherein the protrusion includes a protrusion body that abuts the outer edge of the second terminal, and a sub-protrusion that extends from a distal end of the protrusion body along a rear face of the second terminal.

4. The terminal fastening structure according to claim 3, wherein a tapered portion is fashioned on an inner face of the sub-protrusion facing the rear face of the second terminal, such that a distance between the terminal body and the sub-protrusion expands toward a distal end of the sub-protrusion.

5. The terminal fastening structure according to claim 1, wherein the terminal block is attached to an opening that is opened in a housing for accommodating the motor.
